(19) United States
(12) Patent Application Publication
(10) Pub. No.: US 2002/0005101 A1
(43) Pub. Date: Jan. 17, 2002

(54) System for the continuous separation of strings of material

(76) Inventors: Wilhelm Lohrey, Meerbusch (DE); Stefan Lambertz, Hurth (DE); Wolfgang Groth, Wegberg (DE); Friedhelm Funda, Wuppertal (DE); Wolfgang Reichel, Willich (DE); Michael Klein, Willich (DE)

Correspondence Address: CANTOR COLBURN, LLP, 55 GRIFFIN ROAD SOUTH, BLOOMFIELD, CT, 06002

(21) Appl. No.: 09/849,148

(22) Filed: May 4, 2001

(30) Foreign Application Priority Data
May 11, 2000 (EP) 00 109 939.9
Feb. 9, 2001 (EP) 01 103 057.4

(51) Int. Cl. B26D 1/56; B26D 7/06

(52) U.S. Cl. 83/100; 83/152; 83/323; 83/345

(57) ABSTRACT

This invention relates to a system for the continuous separation of strings of material, subdivided into individual string subsections or pockets by transverse perforations, especially in the context of the production of tea filter bags, incorporating a continuously rotating wheel (1) and, beside the wheel (1), grippers (3) which are tiltable relative to the wheel (1) and serve to grasp the longitudinal sides of a string subsection to be separated from the string at a predefined point near the perforation, said string subsection permitting separation by means of the relative movement between the grippers (3) and the wheel (1).

This invention relates to a system for the continuous separation of strings of material subdivided into individual string subsections by means of a transverse perforation, especially in the context of tea-bag production.

Processes and systems for the continuous production of beverage filter bags and corresponding filter bags have been in existence in numerous variations. For the production of tea bags different strings of materials are used. In one of the current versions, individual portions of an instant beverage substance are deposited on a web of filter paper, the paper is formed into a sleeve which by means of transverse seams is subdivided into individual pockets sealed on all sides and each containing a portion of the substance. The sleeve is formed by an overlapping fold of the web of filter paper, sealed by a longitudinal seam, or by overlaying another sheet of filter paper and providing two longitudinal seams. The result is a string of pockets, or pocket string, consisting of consecutively contiguous pockets, each sealed by a transverse seam and containing a portion of the beverage substance. The transverse seam constitutes both the trailing seam of one pocket and the leading seam of the next following pocket and encompasses between the two seams a perforation along which the pockets are separated during the production process. The separated pockets are ultimately attached to a hanging strip by which the filter bag can be manipulated and suspended. The hanging strips for the filter bags are produced in a continuous operation from strings of material of the type first above mentioned and provided with transverse perforations which define the sections ultimately serving as the hanging strips for the filter bags.

It is the objective of this invention to provide a system for the continuous separation of strings of material of the type first above mentioned, reliably operating at high speed and, most of all, permitting cost-effective production of beverage filter bags.

The technical solution is a system according to this invention, as referred to above, incorporating a continuously rotating wheel, with grippers positioned on the side of the wheel and tiltable relative to the wheel for grasping the longitudinal sides of a subsection of the string to be separated at a predefined point near the perforation, allowing the subsection of the string to be separated by the relative movement between the grippers and the wheel.

According to the invention, the string of material is guided to the continuously rotating wheel, where it is grasped by the grippers positioned beside the wheel, and the relative movement between the grippers and the wheel pulls the subsection of the string apart at the perforation, thus separating it from the strip. The grippers positioned next to the wheel securely guide the string of material in a manner that the subsections and especially the pockets of a pocket string will not be damaged. The system according to this invention thus permits the separation of subsections from a string of material with a high production throughput.

In advantageous fashion, the wheel is provided with recesses distributed over its perimeter for accepting individual subsections i.e. pockets. The recesses suitably match the shape of the pockets and thus help guide the string of material while also aiding precise separation of the pockets. In an enhanced design version of this invention, the recesses in the wheel are equipped with a compressed-air outlet by means of which the individual pockets of a string can be either held in place by negative pressure in the recesses or they can be blown out by positive pressure. In advantageous fashion this allows for the individual pockets of a string in the production of filter bags, and especially tea bags, to be positioned and securely held in the recesses of the wheel for the purpose of continuous separation. It also permits a uniform distribution of the beverage-substance portions in the pockets. In desirable fashion the pockets are pushed out of the recesses in the wheel either concurrently with or following their separation from the pocket string. This ensures that the pockets are not stuck in the recesses of the wheel which would obstruct or interfere with the production process. In one specific embodiment of this invention, the wheel has twelve recesses, distributed over its perimeter, and a pair of grippers is associated with each recess.

In advantageous fashion, the grippers are tiltable in the direction of rotation of the wheel and can be accelerated for generating the relative movement in the direction of rotation of the wheel, preferably by way of a cam mechanism. The grippers are controlled in a manner whereby the forward grippers, as viewed in the direction of rotation of the wheel, grasp the pocket to be separated from the string before the rearward grippers, again as viewed in the direction of rotation, grasp the next following pocket, and the said forward grippers are not accelerated until the said rearward grippers have grasped the next following pocket of the string.

According to an advantageous design of this invention, the grippers feature an upper jaw and a lower jaw, where the lower jaw is fixed while the upper jaw is tiltable for closing the gripper in the radial direction of the wheel. In desirable fashion the tilting function of the upper jaw for closing the gripper is controlled via a cam mechanism. Controlling the tilting and the grasping functions of the grippers via a cam mechanism ensures precise separation of the strings of material.

The following explains additional details, features and advantages of this invention with the aid of a design example depicted in the drawings in which

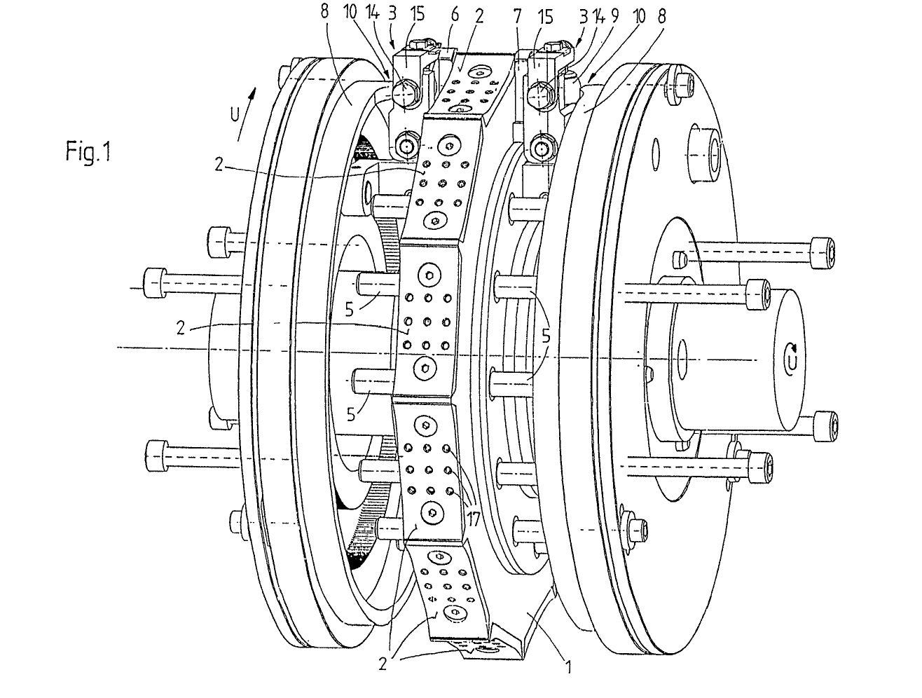

FIG. 1 is a perspective view of a system for the continuous separation of a string of pockets in the production of filter bags for tea;

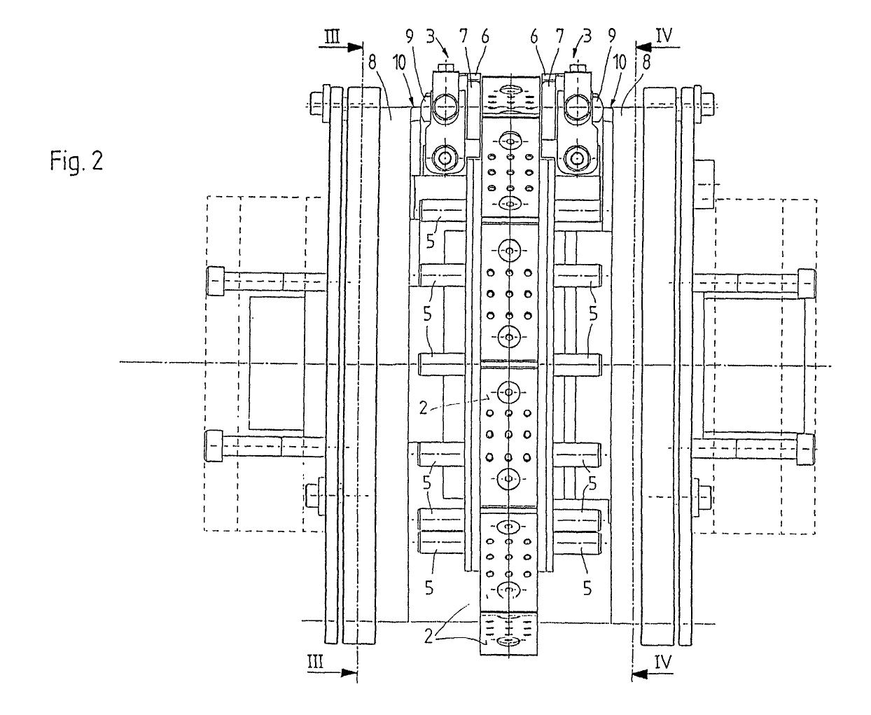

FIG. 2 is a side view of the system as shown in FIG. 1;

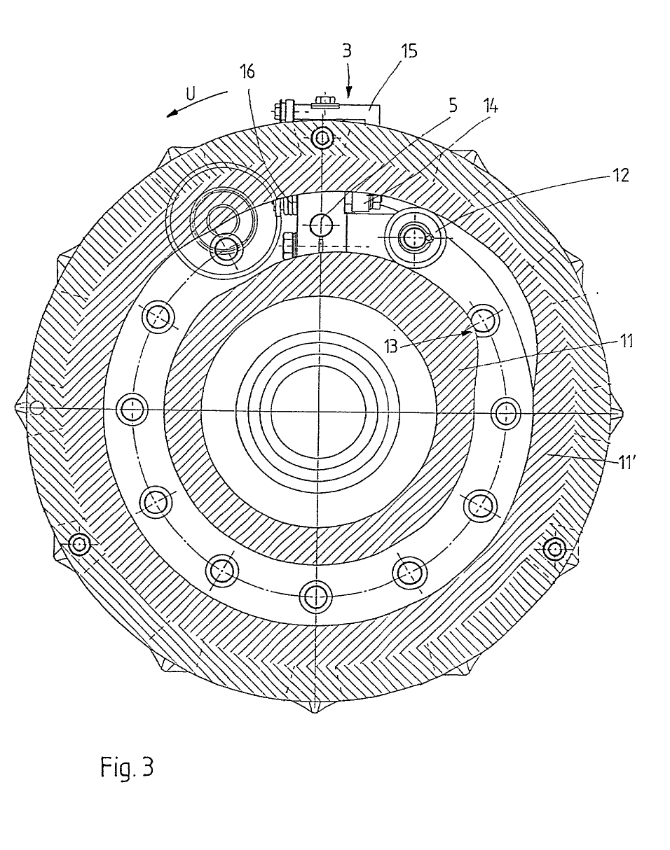

FIG. 3 is a side view along the line III-III in FIG. 2;

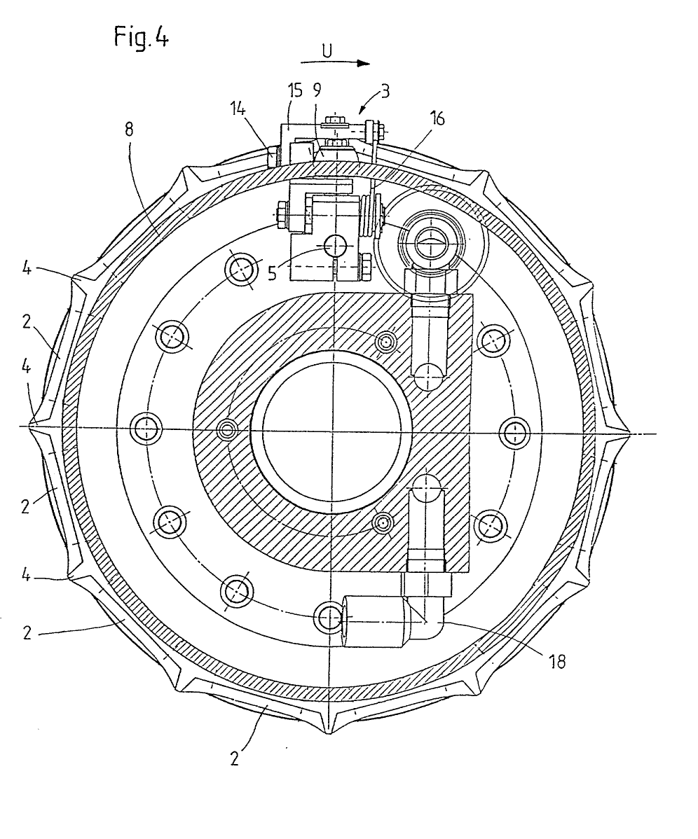

FIG. 4 is a side view along the line IV-IV in FIG. 2; and

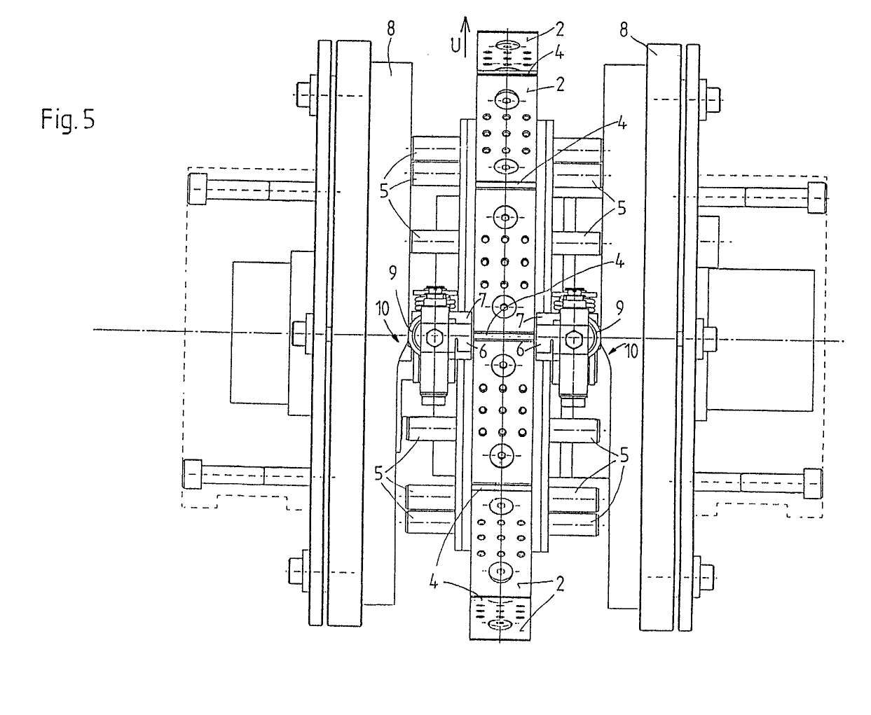

FIG. 5 is a top view of the system as shown in FIG. 1.

The system illustrated in FIGS. 1 to 5 is used for the continuous separation of strings of pockets in the production of filter bags for brewing tea. Pocket strings of this type consists of consecutively contiguous pockets, each sealed by a transverse seam and containing a portion of substance i.e. tea, where the transverse seam includes both the trailing transverse seam of one pocket and the leading seam of the next following pocket and a perforation is situated between the two seams along which perforation the tea bags will be separated during the production process. The system incorporates a continuously rotating wheel I featuring recesses 2 which are distributed over its perimeter and which accept individual pockets of a pocket string. Positioned on either side of the wheel 1 are grippers 3 which are tiltable relative to the wheel 1 and which serve to grasp the longitudinal sides of a pocket, to be separated from a pocket string, at a predefined point near the perforation, allowing the pocket to be separated from the string by a movement of the grippers 3 relative to the wheel 1. For the sake of simplicity the FIGS. 1 to 5 show only one of the gripper pairs composed of the grippers 3 on either side of the wheel 1.

The grippers 3 are tiltably mounted on pivots 5 and can be both tilted and accelerated for generating the relative movement in the direction of rotation of the wheel 1 by way of a cam mechanism. As can be seen in FIG. 3, the grippers 3 are provided with a cam roller 12 which is pulled over a cam 11 or 11′, so that by way of the cam 11 or 11′ the gripper 3 describes the predefined tilting movement around the pivot 5. On their outside and, respectively, inside surfaces the cams 11 and 11′ are provided with protrusions and, respectively, recesses 13 which, by way of the cam roller 12, produce the accelerated swivel movement of the grippers 3 in the direction of rotation “U”. For closing the grippers, each of the grippers 3 features an upper jaw 6, tiltable in the radial direction of the wheel 1, and a fixed lower jaw 7. To close the gripper 3, its upper jaw 6 is tiltable via a cam mechanism. Accordingly, the upper jaw 6 of the gripper 3 connects to an L-shaped elbow 15 which can swivel around a pivot 14 and which is linked to a cam roller 9. The cam roller 9 of the gripper 3 is guided over a cam 8 which is provided with a protrusion and, respectively, a recess 10 perpendicular to both the radial direction and the direction of rotation U of the wheel 1. As the cam roller 9 passes the said protrusion or, respectively, the recess, the upper jaw 6 is caused by the elbow 15 to tilt in the radial direction, enabling it to grasp a pocket out of the pocket string by its longitudinal sides. For reversing the tilting movement of the upper jaw 6 and the elbow 15, the latter connects to a return spring 16. The grasping operation of the gripper 3 is controlled via the cam roller 9 and its lateral cam 8 in such fashion that the forward grippers 3, as viewed in the direction of rotation U of the wheel 1, grasp the pocket to be separated from its string before the rearward grippers, again viewed in the direction of rotation U, grasp the next following pocket. The cam mechanism for the grasping operation is synchronized with the cam mechanism for the acceleration of the grippers in the direction of rotation of the wheel in a way that the said forward grippers 3, as viewed in the direction of rotation of the wheel 1, are accelerated as the said rearward grippers grasp the next following pocket of the pocket string.

As indicated in FIG. 4, the recesses 2 distributed over the perimeter of the wheel 1 are configured to accept a pocket out of a pocket string. In the direction of rotation U the recesses 2 are provided with delimiters 4. Neighboring recesses 2 share one delimiter 4 which, in the radial direction, has a trapezoidally tapering cross section. Each of the recesses 2 is also provided with nine orifices 17 by way of which a pocket out of a pocket string can be either held in place in the recess 2 by vacuum suction or pushed out of the recess 2 by positive pressure. To that end, the orifices 17 in the recesses 2 are provided with compressed-air fittings 18 for the application of negative or positive pressure. The compressed-air fitting 18 for applying the negative or positive pressure is illustrated in FIG. 4.

The system shown in FIGS. 1 to 5, serving to separate a pocket from a string of pockets within the framework of tea-filter-bag production permits the separation of the pockets by pulling the pocket string apart at the perforation. The separation of a pocket from the pocket string is accomplished by guiding the pocket string to a continuously rotating wheel 1 which is provided with recesses 2 for holding individual pockets, where the longitudinal sides of the pocket to be separated from the pocket string are grasped by grippers 3 positioned beside the wheel 1 and the relative movement between the grippers 3 and the wheel 1 causes the pocket to be separated from the pocket string. This design allows machine operation at high cycle rates, permitting the production of 800 to 1500 filter bags per minute.

### List of Reference Numbers

1 Wheel

2 Recess

3 Delimiter

5 Pivot

6 Upper jaw

7 Lower jaw

8 Cam for grasping operation (closing the gripper)

9 Cam roller

10 Protrusion/recess

11, 11′ Cam for relative movement (tilting the gripper in the direction of rotation of the wheel)

12 Cam roller

13 Protrusion/recess

14 Pivot

15 Elbow

16 Return spring

17 Orifice

18 Compressed-air fitting

U Direction of rotation

1. System for the continuous separation of strings of material, subdivided into individual string subsections by transverse perforations, especially in the context of the production of tea filter bags, incorporating a continuously rotating wheel (1) and, beside the wheel (1), grippers (3) which are tiltable relative to the wheel (1) and serve to grasp the longitudinal sides of a string subsection to be separated from the string at a predefined point near the perforation, said string subsection permitting separation by means of the relative movement between the grippers (3) and the wheel (1).

2. System as in claim 1, characterized in that the grippers (3) can be tilted in the direction of rotation of the wheel (1).

3. System as in claim 1 or claim 2, characterized in that for generating the relative movement the grippers (3) can be accelerated in the direction of rotation of the wheel (1).

4. System as in claim 3, characterized in that the grippers (3) can be accelerated via a cam mechanism.

5. System as in one of the claims 1 to 4, characterized in that the grippers (3) incorporate an upper jaw (6) and a lower jaw (7), where the lower jaw (7) is fixed while the upper jaw (6) can be tilted for closing a given gripper (3) in the radial direction of the wheel (1).

6. System as in claim 5, characterized in that, for closing a given gripper (3), the upper jaw (6) can be tilted by way of a cam mechanism.

7. System as in one of the claims 1 to 6, characterized in that the wheel (1) is provided with recesses (2) distributed over its perimeter for accepting individual string subsections.

8. System as in claim 7, characterized in that the recesses (2) are provided with compressed-air fittings permitting the string subsections to be either held in place in the recesses (2) by vacuum suction or blown out by positive air pressure.

9. System as in claim 7 or claim 8, characterized in that the wheel (1) is provided with twelve recesses (2) distributed over its perimeter.

10. System as in one of the claims 7 to 9, characterized in that a pair of grippers is associated with each recess (2).

11. System as in one of the claims 1 to 1 0, characterized in that the grippers (3) are controlled in such fashion that the forward grippers (3), as viewed in the direction of rotation of the wheel (1), grasp the string subsection to be separated before the rearward grippers (3), again viewed in the direction of rotation, grasp the next following string subsection, and the said forward grippers (3) are accelerated as the said rearward grippers (3) grasp the next following subsection of the string.
